(19) United States
(12) Patent Application Publication
(10) Pub. No.: US 2009/0008579 A1
(43) Pub. Date: Jan. 8, 2009

(54) ELECTRON BEAM LITHOGRAPHY APPARATUS AND DESIGN METHOD OF PATTERNED BEAM-DEFINING APERTURE

(75) Inventors: Koji TAKEYA, Kanagawa (JP); Takashi FUSE, Kanagawa (JP); Tadashi KOTSUGI, Kanagawa (JP); N. William PARKER, Pleasanton, CA (US)

Correspondence Address: PILLSBURY WINTHROP SHAW PITTMAN LLP, P.O. BOX 10500, MCLEAN, VA, 22102, US

(73) Assignees: Tokyo Electron Limited, Tokyo (JP); Multibeam Systems Inc., Santa Clara, CA (US)

(21) Appl. No.: 12/209,882

(22) Filed: Sep. 12, 2008

Related U.S. Application Data
(63) Continuation-in-part of application No. 10/962,049, filed on Oct. 7, 2004.
(60) Provisional application No. 60/509,582, filed on Oct. 7, 2003.
(60) Provisional application No. 60/582,014, filed on Jun. 21, 2004.

(51) Int. Cl. G21K 5/00

(52) U.S. Cl. 250/492.23

(57) ABSTRACT

A current density distribution characteristic within a beam pattern on a target object can be improved by using a simple-structured electron optical system and a single patterned beam-defining aperture. With an aperture layout modified to be physically fabricable, a current density distribution within the beam pattern is obtained (S5). Then, a current density uniformity is determined by applying preset determination threshold values to the current density distribution within the beam pattern BP obtained as described above (S6), and if it is found not to fall within a tolerance range, tentative inner block portions are set in tentative electron ray passing areas (S7 and S8). Subsequently, by appropriately iterating steps S5 to S8 for the aperture layout modified or renewed by the tentative inner block portions as described above, the tentative electron ray passing areas and the tentative inner block portions, satisfying determination criteria, are decided (S8).

### CROSS-REFERENCES TO RELATED APPLICATIONS

This application is a continuation-in-part of U.S. patent application Ser. No. 10/962,049, filed on Oct. 7, 2004, which is hereby incorporated by reference in its entirety, which claims the benefit of U.S. Provisional Application Ser. No. 60/509,582 filed on Oct. 7, 2003, and U.S. Provisional Application Ser. No. 60/582,014 filed on Jun. 21, 2004.

### FIELD OF THE INVENTION

The present disclosure relates to a lithography technique for use in a semiconductor process; and, more particularly, to an electron beam lithography apparatus of a shaped beam type and a method for designing a patterned beam-defining aperture to be used therein.

### BACKGROUND OF THE INVENTION

In a manufacturing process of semiconductor devices, there has been conventionally used an electron beam lithography apparatus for writing a pattern with electron beams so as to form a reticle pattern or to form directly a circuit pattern on a resist on a semiconductor wafer.

The most important requirement for the electron beam lithography apparatus has been to minimize time required for writing a pattern. As for a direct-write lithography apparatus, in particular, since exposure time depends on writing time, a variety of research has been carried out to find a way to shorten the writing time. As one example, there has been known a shaped beam type lithography apparatus in which an electron beam is shaped to have a rectangular cross section according to a minimum line width of a circuit pattern, and a desired pattern is written by connecting a number of beam shots.

U.S. patent application Ser. No. 10/962,049 discloses a shaped beam type lithography apparatus in which electron beams passing through a plurality of passing points of a single aperture, which is provided with a multiplicity of openings, are converged into one point within a desired beam pattern on a wafer. In this shaped beam type lithography apparatus, a substantially rectangular opening for allowing electron beams to pass therethrough is provided in a central portion of the aperture, while another opening is provided around this central opening in a ring shape, allowing electron beams to pass therethrough. Here, if this outer opening is continuously formed along the circumferential direction, it might be impossible to physically support a block portion (and the central opening) between the central opening and the outer opening. Thus, block portions (supporting portions) divide the outer opening at several places. Electron rays passing through the central opening of the aperture fall within the desired beam pattern on the wafer due almost entirely to the first-order focusing of a focusing lens. Meanwhile, electron rays passing through the outer opening of the aperture are also allowed to fall within the beam pattern on the wafer while their beam paths are folded over by a large angle, i.e., an angle at the exterior side in a radial direction due to a converging effect (first-order focusing plus spherical aberration) of a focusing lens. Electron rays incident on the block portions other than the central and outer openings are blocked by the block portions. Even if they were to pass through the block portions, they would fall outside the beam pattern on the wafer.

According to the shaped beam type lithography apparatus described in U.S. patent application Ser. No. 10/962,049, it is possible to realize both a beam pattern edge characteristic necessary for the formation of micro-patterns and a current characteristic necessary for the improvement of throughput by using a simple-structured electron optical system with a single aperture. A desirable improvement of the shaped beam type lithography apparatus described in U.S. patent application Ser. No. 10/962,049 would be a further method for controlling (reducing) the current density at the center of the beam.

If the charge deposited by one beam shot (beam current times flash time) is too great, problems may be incurred as follows: (1) electron scattering (particularly, backscattering) could spread out in a resist excessively, resulting in a reduction of resolution; (2) resist exposure sensitivity could fluctuate irregularly due to the influence of heat generated by the electron energy; and (3) pattern distortion such as a proximity effect and the like could be more difficult to correct. Therefore, in a shaped beam system, as described in U.S. patent application Ser. No. 10/962,049, it is desirable to have further options for controlling the total beam current.

### BRIEF SUMMARY OF THE INVENTION

In view of the foregoing, the present invention provides an electron beam lithography apparatus capable of achieving a beam pattern edge characteristic necessary for the formation of micro-patterns and a current characteristic necessary for the improvement of throughput by using a simple-structured electron optical system and a single patterned beam-defining aperture, while also capable of improving the current density distribution characteristics within a beam pattern on a target object.

Further, the present invention also provides a design method for efficiently determining an improved layout of a patterned beam-defining aperture, capable of generating more uniform current density distribution characteristics within a beam pattern in a shaped beam type lithography apparatus.

To achieve the object of the present invention, there is provided an electron beam lithography apparatus including: an electron beam generator for generating an electron beam toward a target object on a stage; a first electron lens disposed between the electron beam generator and the stage, for focusing the electron beam on the target object; and a patterned beam-defining aperture disposed between the electron beam generator and the first electron lens to define a spot of the electron beam focused on the target object into a pattern of a desired shape and size, and having a plurality of discretely distributed electron ray passing areas for allowing a part of electron rays, which are supposed to fall within the beam pattern on the target object, to pass therethrough, among the electron rays constituting the electron beam incident from the electron beam generator, wherein the patterned beam-defining aperture has, within at least one of the electron ray passing areas, an inner block portion for blocking electron rays which would otherwise land on a central portion of the electron beam pattern.

Further, in accordance with the present invention, there is provided a patterned beam-defining aperture disposed, in an electron beam lithography apparatus, between an electron beam generator for generating an electron beam toward a target object on a stage and an electron lens for focusing the electron beam on the target object, for defining a spot of the electron beam focused on the target object into an electron beam pattern of a desired shape and size, the aperture including: a plurality of discretely distributed electron ray passing areas for allowing a part of electron rays, which are supposed to fall within the beam pattern on the target object, to pass therethrough, among the electron rays constituting the electron beam incident from the electron beam generator; and an inner block portion provided within at least one of the electron ray passing areas, for blocking electron rays which would otherwise land on a central portion of the electron beam pattern.

In accordance with the configuration of the electron beam lithography apparatus or the patterned beam-defining aperture, the electron beam emitted from the electron beam generator is incident on the patterned beam-defining aperture, and, among the electron rays constituting the electron beam, electron rays having passed through the electron ray passing areas fall within the spot of the electron beam focused as a specific pattern on the target object. Sufficiently large current amount may be obtained because the electron rays are gathered within the beam pattern BP on the target object after passing through a multiplicity of the electron ray passing areas. Further, by allowing electron rays which would otherwise land outside of the beam pattern on the target object to be incident on a block area (thereby preventing these rays from reaching the target object), an edge characteristic of the current density distribution within the beam pattern can be improved. Furthermore, by blocking electron rays which would otherwise land on the central portion of the beam pattern on the target object by using the inner block portion installed in the electron ray passing areas, protrusion of the central portion in the current density distribution profile within the beam pattern can be controlled and thus, uniformity can be improved.

In accordance with a desirable aspect of the present invention, the aperture is configured to give a 1 to N (N is an integer no smaller than 2) mapping of electron ray landing points within the electron beam pattern on the target object to electron ray passing points on the patterned beam-defining aperture.

In accordance with another desirable aspect of the present invention, the electron ray passing areas of the patterned beam-defining aperture include a central passing area having a contour approximately corresponding to the electron beam pattern; and an outer passing area placed around the central passing area. Here, an outer block portion made up of an area other than the central and outer passing areas of the patterned beam-defining aperture functions to block electron rays incident from the electron beam generator. More desirably, the outer block portion may be set to block all or most of electron rays which would otherwise fall outside the electron beam pattern on the target object.

Further, when the requirements for mechanical support of the central part of the patterned beam-defining aperture are taken into account, the outer passing area may be divided into a multiplicity of divided outer passing areas separated from each other in the circumferential direction of the central passing area. For example, the contour of the central passing area is set to have a substantially square shape, and a multiplicity of the outer passing areas are set to have four side areas facing four sides of the central passing area, respectively, and four diagonal areas facing four corners of the central passing area, respectively.

As a desired aspect of the inner block portion in accordance with the present invention, in the central passing area, the inner block portion is disposed at a central portion thereof, and an opening for allowing electron rays to pass therethrough is provided around the inner block portion. In this case, bridge portions for physically supporting the inner block portion may be installed to be extended from the outer block portion to the inner block portion across the opening. The inner block portion may be of any shape, desirably, a polygonal shape.

In accordance with another desirable aspect of the present invention, in the central passing area, a plurality of small holes for allowing electron rays to pass therethrough may be arranged in a specific pattern, and the other region (other than where the small holes are present) may constitute the inner block portion. In this case, it is desirable that the small holes are arranged outside a central block region, having a desired shape (for example, a square or a circle) and a desired area, located in a central portion of the central passing area in order to efficiently suppress the current density in the central portion within the electron beam pattern on the target object.

In accordance with still another desirable aspect of the present invention, in a radial direction with respect to a central point of the central passing area, the inner block portion is provided at a central portion of the outer passing area, and an opening for allowing electron rays to pass therethrough is provided around the inner block portion. In this case, it is desirable to install a bridge portion extended from the outer block portion to the inner block portion across the opening in order to physically support the inner block portion.

As a desirable aspect of the electron optical column in the electron beam lithography apparatus in accordance with the present invention, disposed between the electron beam generator and the patterned beam-defining aperture is a beam blanker for blanking the electron beam by deviating the electron beam from the electron ray passing areas of the aperture. Disposed between the electron beam generator and the beam blanker is a trimming aperture for trimming a cross sectional shape of the electron beam in a desired shape. Disposed between the patterned beam-defining aperture and the first electron lens is a deflector for deflecting the electron beam. Further, the electron beam generator includes a field emission electron gun for extracting electrons by applying a high electric field to a cathode tip, and disposed in a vicinity of the electron beam generator is a second electron lens for collimating electron beams emitted from the field emission electron gun at a specific emission angle into parallel beams kept in a streamline flow state.

In accordance with the present invention, there is provided a method for designing a patterned beam-defining aperture disposed, in an electron beam lithography apparatus, between an electron beam generator for generating an electron beam toward a target object on a stage and an electron lens for focusing the electron beam on the target object, for defining a spot of the electron beam focused on the target object into a pattern of a desired shape and size, the method including: a first step of designing the shape and size of the electron beam pattern on a target object; a second step of analyzing trajectories of electron rays constituting the electron beam generated from the electron beam generator, based on specific conditions and constants in an electron optical system of the electron beam lithography apparatus; a third step of setting the position where the patterned beam-defining aperture is to be located, a tentative electron ray passing area for allowing all or most of electron rays supposed to fall within the electron beam pattern on the target object to pass therethrough and an outer block portion for blocking all or most of the electron rays which would otherwise land outside the electron beam pattern on the target object; a fourth step of investigating a landing point of each electron ray passing through the tentative electron ray passing area within the electron beam pattern on the target object and obtaining a current density distribution within the electron beam pattern; a fifth step of determining uniformity of the current density distribution within the electron beam pattern; a sixth step of setting, in the tentative electron ray passing area, a tentative inner block portion having a desired shape and size, for blocking a part of the electron rays to improve the uniformity of the current density distribution, and modifying an electron ray passing characteristic of the tentative electron ray passing area; a seventh step of iterating the fourth step and the fifth step until the uniformity of the current density distribution falls within a preset tolerance range, while varying the shape or the size of the tentative inner block portion in the sixth step; and an eighth step of determining the tentative electron ray passing area and the tentative inner block portion obtained after the completion of the seventh step as a final electron ray passing area and a final inner block portion which are to be actually fabricated in the patterned beam-defining aperture.

In accordance with the above design method, an improved layout of a patterned beam-defining aperture, capable of generating more uniform current density distribution characteristics within a beam pattern in a shaped beam method, can be determined efficiently by iterating the determining step whether the uniformity of the current density distribution falls within a preset tolerance range, while varying (modifying) the shape or the size of the tentative inner block portion in the tentative electron ray passing area after obtaining the current density distribution within the electron beam pattern on the target object.

In accordance with a desirable aspect of the present invention, in the third step, the tentative electron ray passing area may be set to be discretely distributed into a plurality of areas. In this case, the tentative electron ray passing area may be set to have a tentative central passing area having a contour corresponding approximately to the electron beam pattern and a tentative outer passing area placed around the tentative central passing area. Here, the tentative outer passing area may consist of a multiplicity of tentative divided outer passing areas separated from each other in the circumferential direction. Further, desirably, the contour of the tentative central passing area is set to have a substantially square shape, and the tentative divided outer passing areas are set to have four tentative side areas facing four sides of the tentative central passing area, respectively, and four tentative diagonal areas facing four corners of the tentative central passing area, respectively.

In accordance with another desirable aspect of the present invention, in the sixth step, it is possible to adopt a method in which the tentative inner block portion is set in a central portion of the tentative central passing area, and the area of the tentative inner block portion may be gradually enlarged to improve the uniformity of the current density distribution.

Otherwise, in the sixth step, it is also possible to employ a method in which a plurality of tentative small holes for allowing electron rays to pass therethrough are arranged within the tentative central passing area in a specific pattern, and the number of the tentative small holes is gradually reduced to improve the uniformity of the current density distribution.

Further, in the sixth step, it is also possible to employ a method in which a plurality of tentative small holes for allowing electron rays to pass therethrough are arranged within the tentative central passing area in a specific pattern, and the diameter of the tentative small holes is gradually reduced to improve the uniformity of the current density distribution.

Furthermore, in the sixth step, it is also possible to adopt a method in which the tentative inner block portion is set at a central portion of the tentative outer passing area in a radial direction with respect to a central point of the tentative central passing area, and the area of the tentative inner block portion is gradually enlarged to improve the uniformity of the current density distribution.

In accordance with still another aspect of the present invention, there is provided a patterned beam-defining aperture disposed, in an electron beam lithography apparatus, between an electron beam generator for generating an electron beam toward a target object on a stage and an electron lens for focusing the electron beam on the target object, for defining a multiplicity of spots of the electron beam focused on the target object into electron beam patterns of a desired shape and size by a single beam shot, the aperture including: a plurality of discretely distributed electron ray passing areas for allowing a part of electron rays, which are supposed to fall within the beam patterns on the target object, to pass therethrough, among the electron rays constituting the electron beam incident from the electron beam generator; and an inner block portion provided within at least one of the electron ray passing areas, for blocking electron rays which would otherwise to land on a portion of the electron beam patterns.

In accordance with still another aspect of the present invention, there is provided an electron beam lithography apparatus including: an electron beam generator for generating an electron beam toward a target object on a stage; a first electron lens disposed between the electron beam generator and the stage, for focusing the electron beam on the target object; and a patterned beam-defining aperture disposed between the electron beam generator and the first electron lens to define a multiplicity of spots of the electron beam focused on the target object into electron beam patterns of a desired shape and size by a single beam shot, and having a plurality of discretely distributed electron ray passing areas for allowing a part of electron rays, which are supposed to fall within the beam patterns on the target object, to pass therethrough, among the electron rays constituting the electron beam incident from the electron beam generator, wherein the patterned beam-defining aperture has, within at least one of the electron ray passing areas, an inner block portion for blocking electron rays which would otherwise land on a portion of the electron beam patterns.

In accordance with still another aspect of the present invention, there is provided an electron beam lithography apparatus including: an electron beam generator for generating an electron beam toward a target object on a stage; a first electron lens disposed between the electron beam generator and the stage, for focusing the electron beam on the target object; a multiplicity of patterned beam-defining apertures, each disposed between the electron beam generator and the first electron lens to define at least one spot of the electron beam focused on the target object into at least one electron beam pattern of a desired shape and size by a single beam shot, and having a plurality of discretely distributed electron ray passing areas for allowing a part of electron rays, which are supposed to fall within said at least one beam pattern on the target object, to pass therethrough, among the electron rays constituting the electron beam incident from the electron beam generator; and a first deflector disposed between the electron beam generator and the multiplicity of patterned beam-defining apertures, for selecting one aperture through which the electron beam passes among the multiplicity of patterned beam-defining apertures by deflecting the electron beam, wherein the patterned beam-defining aperture has, within at least one of the electron ray passing areas, an inner block portion for blocking electron rays which would otherwise land on a portion of said at least one electron beam pattern.

In accordance with the electron beam lithography apparatus of the present invention, due to the above-described configuration and function, a beam pattern edge characteristic necessary for the formation of micro-patterns and a current characteristic necessary for the improvement of throughput can be guaranteed, and a current density distribution characteristic within the beam pattern on the target object can be improved, by using a simple-structured electron optical system and at least one patterned beam-defining aperture.

Moreover, in accordance with the design method for the patterned beam-defining aperture in the present invention, it is possible to efficiently determine an improved layout of the patterned beam-defining aperture for generating a more uniform current density distribution characteristic within the beam pattern in a shaped beam type lithography apparatus.

### BRIEF DESCRIPTION OF THE DRAWINGS

The disclosure may best be understood by reference to the following description taken in conjunction with the following figures:

FIG. 1 provides a longitudinal cross sectional view of an electron optical column of an electron beam lithography apparatus in accordance with an embodiment of the present invention;

FIG. 2 sets forth a flowchart to describe a design procedure for a patterned beam-defining aperture in accordance with the embodiment of the present invention;

FIG. 3 depicts a plan view to illustrate an ideal aperture layout without considering a current density distribution profile within a beam pattern in accordance with the embodiment of the present invention;

FIGS. 4A to 4B show landing points of electron rays passing through tentative electron ray passing areas within a beam pattern on a wafer in case of the aperture layout of FIG. 3;

FIG. 5A presents a plan view showing an aperture layout modified from that of FIG. 3 in a way to be physically fabricable as a stencil mask;

FIG. 5B shows an illustrative current density distribution across the middle of a beam pattern on a wafer obtained from the aperture layout of FIG. 5A;

FIG. 6A is a plan view showing an aperture layout modified by adding an example inner block portion to the tentative electron ray passing areas in the aperture layout of FIG. 5A;

FIG. 6B shows an illustrative current density distribution across the middle of a beam pattern on a wafer obtained from the aperture layout of FIG. 6A;

FIG. 7A provides a plan view showing an aperture layout re-modified by enlarging the inner block portion within the tentative electron ray passing areas in the aperture layout of FIG. 6A;

FIG. 7B shows an illustrative current density distribution across the middle of a beam pattern on a wafer obtained from the aperture layout of FIG. 7A;

FIG. 8A sets forth a plan view showing an aperture layout modified by adding another example of inner block portions to the tentative electron ray passing areas in the aperture layout of FIG. 5A;

FIG. 8B shows an illustrative current density distribution across the middle of a beam pattern on a wafer obtained from the aperture layout of FIG. BA;

FIG. 9A depicts a plan view showing an aperture layout re-modified by enlarging the inner block portions in the tentative electron ray passing areas in the aperture layout of FIG. 8A;

FIG. 9B shows an illustrative current density distribution across the middle of a beam pattern on a wafer obtained from the aperture layout of FIG. 9A;

FIG. 10 is a plan view showing an aperture layout obtained by maximizing the inner block portions in the aperture layout of FIG. 8A or FIG. 9A;

FIG. 11 presents a plan view illustrating an aperture layout provided with a number of small holes in a central passing area of electron ray passing areas;

FIGS. 12A to 12C provide plan views to describe an example sequence for modifying the aperture layout of FIG. 11 in the design of a patterned beam-defining aperture;

FIG. 13 shows two aperture layouts in a single figure to compare aperture sizes thereof easily.

FIG. 14A is a plan view showing an example aperture layout for forming four electron beam patterns by a single beam shot;

FIG. 14B shows an illustrative current density distribution across the middle of beam patterns on a wafer obtained from the aperture layout of FIG. 14A;

FIG. 15A presents a plan view of an aperture layout modified by adding example bridge block portions and corner block portions to the tentative electron ray passing areas in the aperture layout of FIG. 14A;

FIG. 15B shows an illustrative current density distribution across the middle of beam patterns on a wafer obtained from the aperture layout of FIG. 15A; and

FIG. 16 provides a longitudinal cross sectional view of an electron optical column of an electron beam lithography apparatus in accordance with another embodiment of the present invention.

### DETAILED DESCRIPTION OF THE INVENTION

Hereinafter, embodiments of the present invention will be described with reference to the accompanying drawings which form a part hereof.

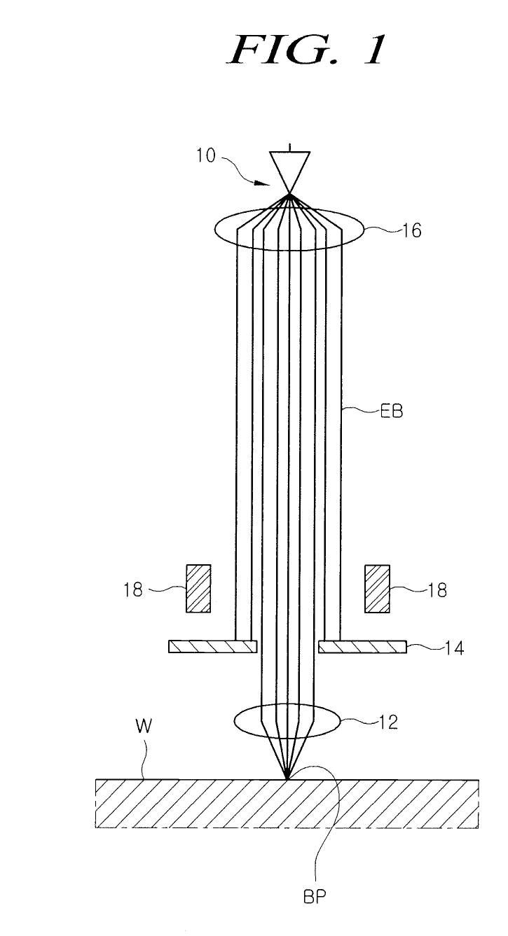

Referring to FIG. 1, there is illustrated a basic configuration of an electron optical column of an electron beam lithography apparatus in accordance with an embodiment of the present invention. The electron beam lithography apparatus is typically used in an electron beam exposure process for directly writing a circuit pattern on a resist on a target object to be processed, e.g., a semiconductor wafer W, by using electron beams.

The electron optical column shown in FIG. 1 basically functions to irradiate shaped beam type electron beams to the semiconductor wafer W mounted on a movable stage (not shown) to thereby expose the resist on a wafer surface by a regular-sized rectangle-patterned beam spot for every beam shot. In addition, this electron optical column also has a function of deflection-scanning the electron beams within a certain range.

The electron optical column mainly includes an electron beam generator 10 for generating an electron beam EB toward the semiconductor wafer W on the stage; a convergence lens 12, disposed between the electron beam generator 10 and the stage, for focusing the electron beam EB on wafer W; and a patterned beam-defining aperture 14, disposed between the electron beam generator 10 and the convergence lens 12, for defining a beam spot BP of the electron beam EB focused on the semiconductor wafer W into a pattern of a desired shape and size.

To be more specific, the electron beam generator 10 includes, for example, a field emission electron gun. Electrons are emitted from a front end of a tip of the electron gun, and electron beams EB are collimated into parallel beams by a collimation lens 16, and then are accelerated by an accelerator. Each electron beam EB emitted from this electron beam generator 10 is made up of a number of electron rays kept in a streamline flow state. Disposed between the electron beam generator 10 and the patterned beam-defining aperture 14 is a beam blanker 18 or the like.

The patterned beam-defining aperture 14 is a stencil mask formed of a conductive material, which serves to allow a part of the electron rays, which are supposed to fall within the defined beam pattern BP on the wafer W, to pass through discrete electron ray passing areas, among the electron rays constituting the electron beams EB incident from the electron beam generator 10, while blocking the remainder of the electron rays. The configuration and function of the patterned beam-defining aperture 14 is a primary inventive feature of the present invention, and will be described later in further detail.

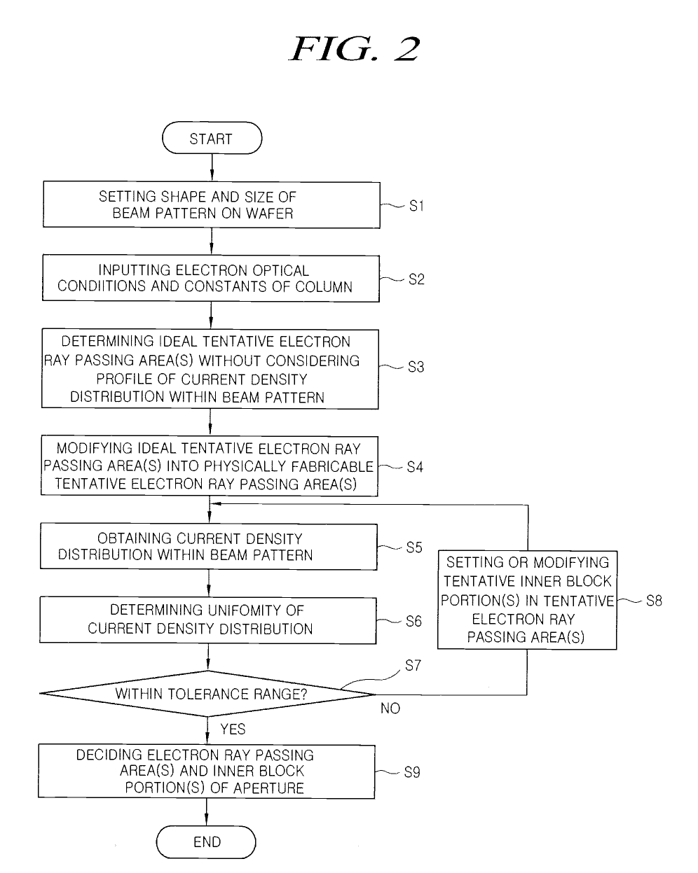

FIG. 2 sets forth a flowchart to describe a design procedure for the patterned beam-defining aperture 14 used in the electron optical column in accordance with the embodiment of the present invention. This aperture design procedure is implemented by a software-driven operation process on a computer.

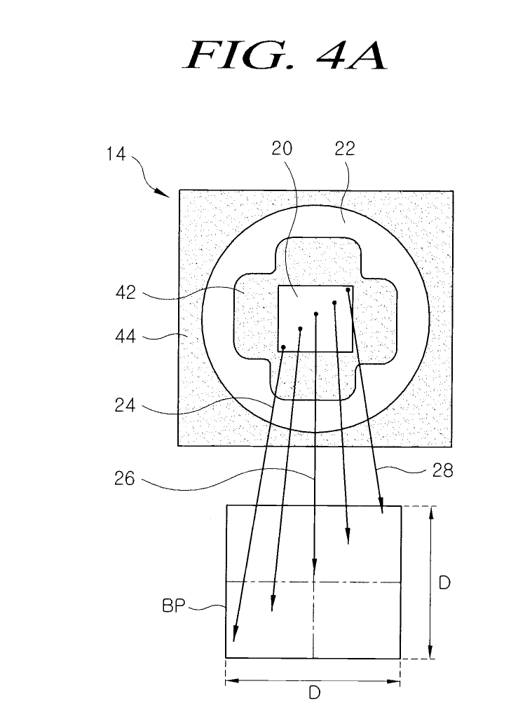

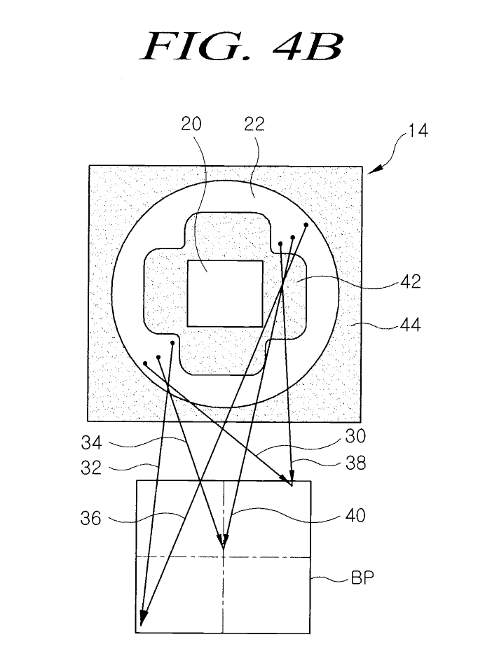

First, based on the dimensions of a circuit pattern to be formed on a semiconductor wafer W to be processed, there is determined a shape and size of a pattern of a beam spot (BP) (hereinafter, simply referred to as a “beam pattern BP”) to be formed on the wafer W by a single beam shot (step S1). In this embodiment, since the shape of the beam pattern BP is defined as a substantially square shape, it would be desirable to simply set a length D of one side of the square (see FIG. 4A).

Thereafter, various electron optical conditions (parameters) and constants, which are determined depending on the configuration and setting values of each component of the electron optical column (See FIG. 1), are inputted (step S2).

Subsequently, based on these electron optical parameters and constants, by analyzing a trajectory of each of the electron rays constituting the electron beams EB emitted from the electron beam generator 10, particularly, trajectories of all electron rays that are likely to land on the wafer W after passing through the patterned beam-defining aperture 14, ideal tentative electron passing areas of the patterned beam-defining aperture 14 are determined without considering a profile of current density within the beam pattern BP (step S3).

Typically, in this type of electron optical column, such idealized tentative electron passing areas are required to be openings for allowing all the electron rays supposed to fall within the beam pattern BP to pass therethrough, while completely blocking electron rays which would otherwise fall outside the beam pattern BP. To elaborate with reference to FIGS. 4A and 4B, the tentative electron passing areas determined in step S3 include a tentative central passing area 20 formed as an approximately square opening and a tentative outer passing area 22 formed as an annular opening surrounding the tentative central passing area 20.

Here, among the electron rays incident on the patterned beam-defining aperture 14 from the electron beam generator 10, all electron rays having passed through the tentative central passing area 20 fall within the beam pattern BP on the wafer W. For example, as schematically illustrated in FIG. 4A, an electron ray 24 having passed through a left lower corner portion of the tentative central passing area 20 arrives at a left lower corner portion within the beam pattern BP; an electron ray 26 having passed through a central portion of the tentative central passing area 20 arrives at a central portion within the beam pattern BP; and an electron ray 28 having passed through a right upper corner portion of the tentative central passing area 20 reaches a right upper corner portion within the beam pattern BP. As described above, the electron ray landing points within the beam pattern BP and the electron ray passing points within the tentative central passing area 20 have one-to-one mapping relationship.

Meanwhile, all electron rays having passed through the tentative outer passing area 22 also fall within the beam pattern BP on the wafer W. For example, as schematically illustrated in FIG. 4B, if attention is paid to a portion of the tentative outer passing area 22 diagonally facing a left lower corner portion of the tentative central passing area 20, an electron ray 30 having passed through an outer edge position arrives at a right upper corner portion within the beam pattern BP; an electron ray 32 having passed through an inner edge position arrives at a left lower corner portion within the beam pattern BP; and an electron ray 34 having passed through a midway position between the outer edge position and the inner edge position reaches a central portion within the beam pattern BP. Furthermore, as for a portion of the tentative outer passing area 22 diagonally facing a right upper corner of the tentative central passing area 20, an electron ray 36 having passed through an outer edge position arrives at the left lower corner portion within the beam pattern BP; an electron ray 38 having passed through an inner edge position arrives at the right upper corner portion within the beam pattern BP; and an electron ray 40 having passed through a midway position between the outer edge position and the inner edge position arrives at the central portion within the beam pattern BP. That is, the electron ray landing points within the beam pattern BP and the electron ray passing points within the tentative outer passing area 22 have a 1-to-N (N is an integer no smaller than 2) mapping relationship between the beam pattern BP and the plane of the patterned beam-defining aperture 14.

In the patterned beam-defining aperture 14, areas 42 and 44 constitute block areas so that electron rays incident on these areas 42 and 44 are completely blocked off. Here, if electron rays incident on the block area 42 were to pass through block area 42, they would fall outside the beam pattern BP on the wafer W. Likewise, if electron rays incident on the block area 44 were to pass through block area 44, they would fall outside the beam pattern BP on the wafer W.

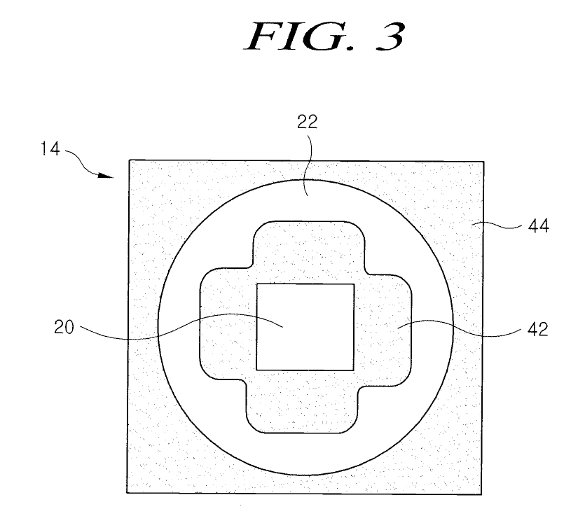

The patterned beam-defining aperture 14 as shown in FIG. 3 may be realized by forming, on a membrane transmitting electron rays, a conductive film (for example, a tungsten film) which constitutes the outer block areas. However, if the aperture 14 is designed as a stencil mask of an opening type, its realization may be impossible because there is no means to physically support the inner side outer block area 42 and the tentative central passing area 20.

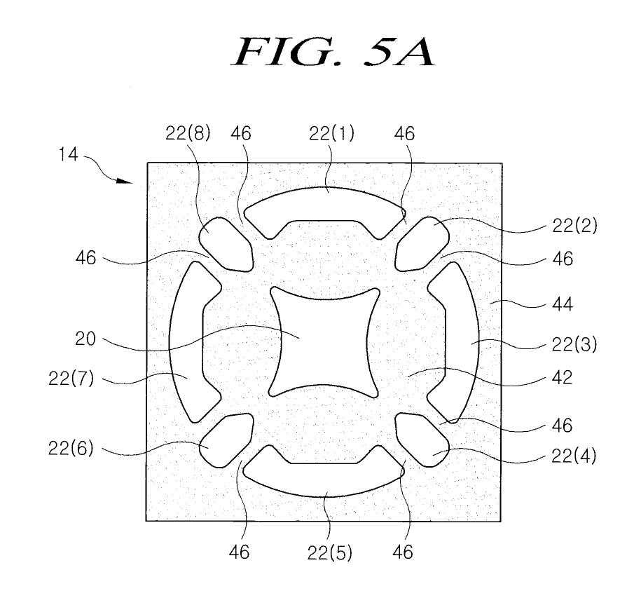

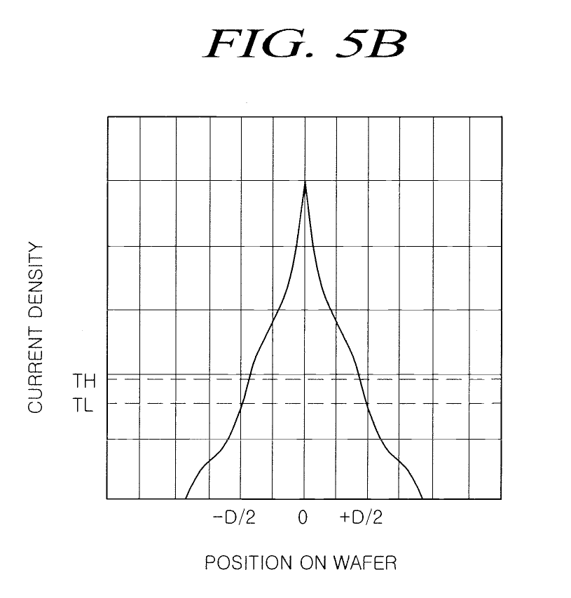

Here, by dividing the tentative outer passing area 22 at several places, it is modified into a physically fabricable tentative electron ray passing areas (step S4). Desirably, as illustrated in FIG. 5A, the tentative outer passing area 22 is divided into 8 parts, i.e., four tentative side areas 22(1), 22(3), 22(5) and 22(7) respectively facing four sides of the tentative central passing area 20 and four tentative diagonal areas 22(2), 22(4), 22(6) and 22(8) respectively facing four corners of the tentative central passing area 20, and bridge-shaped supporting portions 46 connecting the inner side outer block area 42 and the outer side outer block area 44 are installed between the divided outer passing areas. Electron rays incident on these supporting portions 46 are blocked, though they would fall within the beam pattern BP on the wafer W if they were to pass through the supporting portions 46 without being blocked thereby.

Moreover, as illustrated in FIG. 5A, to enhance beam intensities at the four corners of the tentative central passing area 20, edge portions of the four corners of the tentative central passing area 20 are protruded outward in a diagonal direction so that edge portions of the four sides of the tentative central passing area 20 are curved inward. Simply, the tentative central passing area 20 can be of a standard square shape, as shown in FIG. 3.

Here, as for the aperture layout modified to be physically fabricable as shown in FIG. 5A, a current density distribution is calculated by investigating landing points of all electron rays passing through the tentative electron ray passing areas 20 and 22(1) to 22(8) within the beam pattern BP on the wafer W and, then, summing up electron incident amounts on each position within the beam pattern BP (step S5). As a result, a current density distribution profile through the middle of the beam pattern BP may be obtained, such as shown in FIG. 5B. The profile in FIG. 5B is provided only to illustrate the invention and is not intended to be an accurate representation of the true current density profile.

In FIG. 5B, the position of “0” on the wafer refers to the central position of the beam pattern BP, while the positions of “−D/2” and “+D/2” represent two opposite X-directional (or Y-directional) edge positions of the beam pattern BP. As shown in FIG. 5B, the current density distribution within the beam pattern BP is shown as a sharply sloped mountain shape with a high central portion. Such a profile is obtained because electron rays are concentrated by spherical aberration in lens 12 at the central portion of the beam pattern BP after passing through the tentative central passing area 20 and the tentative outer passing areas 22(1) to 22(8). Note, that the effects of finite source size and chromatic aberrations, which reduce the height and sharpness of the central portion of the profile, have not been included in this illustrative profile.

Meanwhile, a current density characteristic at the edge portions of the beam pattern BP is advantageous. That is, it is possible to easily obtain a sufficiently high current density (for example, no smaller than about 3000 A/cm²) inside the edge portions in view of the electron beam exposure, and, further, it is also possible to sharply lower a current density outside the edge portions.

Subsequently, the current density uniformity is determined by applying preset determination threshold values to the current density distribution within the beam pattern BP obtained as described above (step S6). For example, as the determination threshold values, a current density obtained at the edge portions of the beam pattern BP is set as a lower threshold value TL, and there is also set an upper threshold value TH greater than the lower threshold value TL by a preset value (for example, 1000 A/cm²). A range between the lower threshold value TL and the upper threshold value TH is set as a tolerance range. Then, it is determined whether current densities fall within the tolerance range from TL to TH.

As a result of the determination, the current densities within the beam pattern BP obtained from the aperture layout of FIG. 5A can be found not to fall within the tolerance range from TL to TH (step S7).

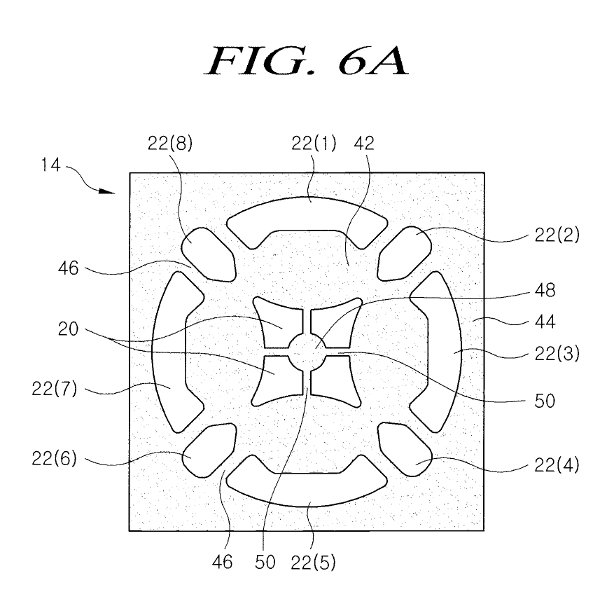

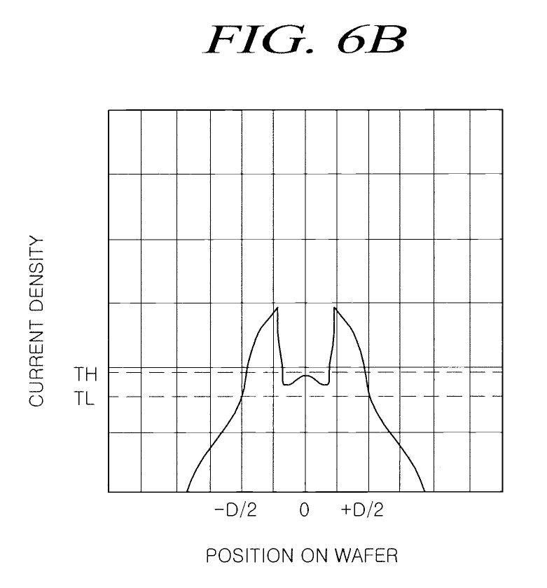

In this case, an appropriate tentative inner block portion is provided in at least one of the tentative electron ray passing areas 20 and 22(1) to 22(8) (step S8). For example, as shown in FIG. 6A, a tentative inner block portion 48 of a circular shape having an appropriate diameter is provided at the central portion of the tentative central passing area 20. In this case, also provided to physically support the tentative inner block portion 48 are bridge portions 50 extending from the inner side outer block area 42 to the tentative inner block portion 48 across the opening portion of the tentative central passing area 20. Electron rays incident on the tentative inner block portion 48 and the bridge portion 50 are blocked, though they would reach the central portion within the beam pattern BP on the wafer W if they were to pass through the tentative inner block portion 48 or the bridge portions 50.

Then, as for the aperture layout (FIG. 6) modified or renewed by the addition of the tentative inner block portion 48, landing points of the electron rays passing through the tentative electron ray passing areas 20 and 22(1) to 22(8) within the beam pattern BP on the wafer are investigated, and the current density distribution is obtained by summing up incident electron amounts in respective positions within the beam pattern BP (step S5). Here, the current density distribution can be more simply calculated by investigating landing points of the electron rays incident on the tentative inner block portion 48 and the bridge portions 50 within the beam pattern BP on the wafer and, then, excluding a current density of the electron rays incident on the tentative inner block portion 48 and the bridge portions 50 from the current density distribution obtained for the aperture layout (FIG. 5A) before modification.

Assume that a current density distribution profile as shown in FIG. 6B, for example, is obtained as a result. In this case, by applying the same determination threshold values TL and TH thereto, the current density uniformity is determined (step S6). As a result, it can be found that the current densities across the middle of the beam pattern BP obtained from the aperture layout of FIG. 6A do not also fall within the tolerance range from TL to TH (step S7).

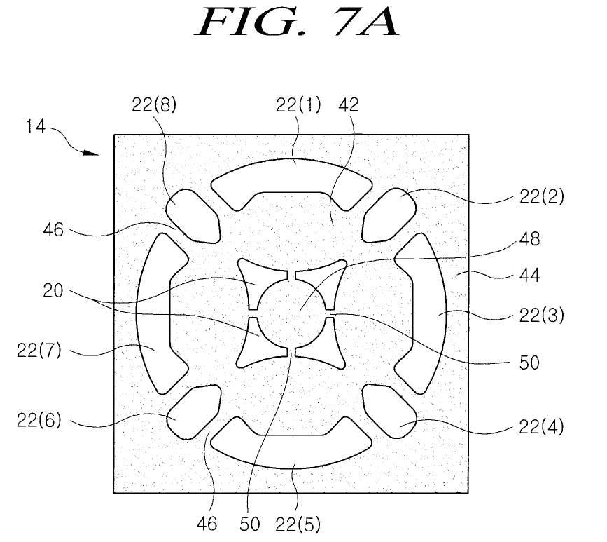

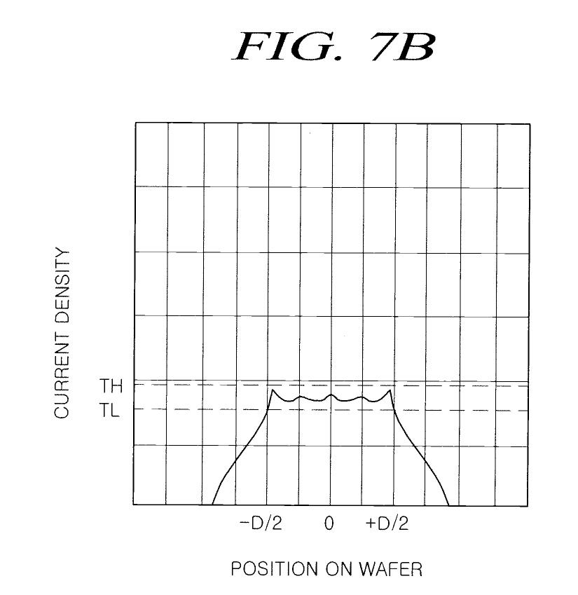

Here, as for the tentative electron ray passing areas 20 and 22(1) to 22(8), the layout of the tentative inner block portion is re-modified (step S8). In this case, the diameter (area) of the tentative inner block portion 48 set within the tentative central passing area 20 may be enlarged properly, as illustrated in FIG. 7A. Then, for this re-modified aperture layout (FIG. 7A), the current density distribution is calculated through the same operation process as described above (step S5), and the current density uniformity is estimated by applying the determination threshold values TL and TH thereto (step S6). As a result, a current density distribution profile across the middle of the beam pattern BP obtained from the aperture layout of FIG. 7A is as shown in FIG. 7B, and current densities are found to fall within the tolerance range from TL to TH (step S7).

If the current density uniformity within the beam pattern BP is within the tolerance range TL to TH, the aperture layout modification process is terminated, and the final electron ray passing area and the final inner block portion of the patterned beam-defining aperture 14 are decided (step S9). That is, the final-version of tentative electron ray passing areas 20 and 22(1) to 22(8) and tentative inner block portion 48 are determined as the actual electron ray passing area and inner block portion for the manufacture of the patterned beam-defining aperture 14.

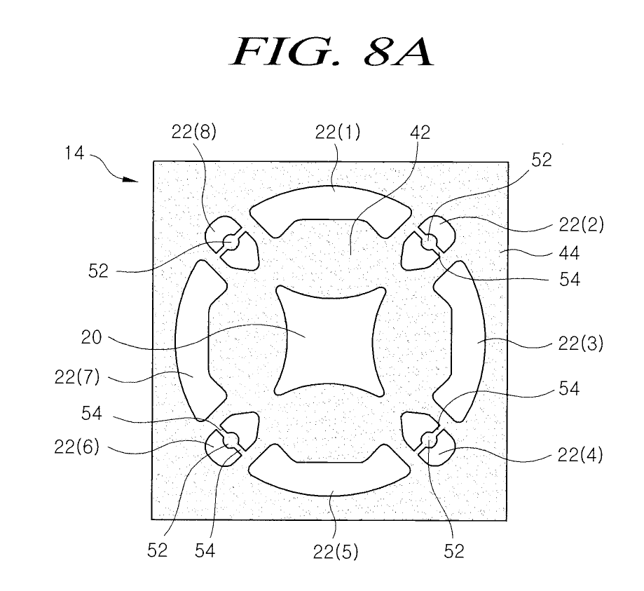

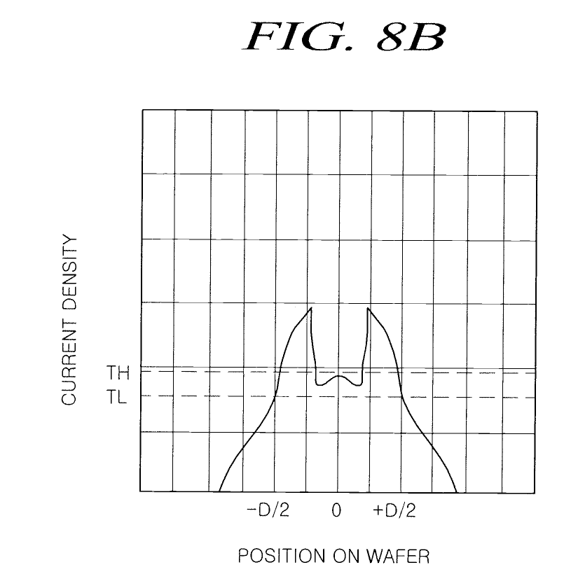

As another example of the tentative inner block portion, instead of setting the tentative inner block portion 48 in the tentative central passing area 20, in the step S8 of the first time, as shown in FIG. 6A, it may be also possible to set, for example, a tentative circular inner block portion 52 within each of the tentative diagonal areas 22(2), 22(4), 22(6) and 22(8) among the tentative outer passing areas 22(1) to 22(8), as shown in FIG. 8A. In this case, the tentative inner block portion 52 is disposed at the central portion of each of the tentative diagonal areas 22(2), 22(4), 22(6) and 22(8) in a diagonal direction, and each tentative inner block portion 52 may be provided with bridge portions 54 which cross each tentative diagonal area in a circumferential direction to physically support the tentative inner block portion 52.

Further, as for the modified aperture layout as shown in FIG. 8A, the current density distribution is calculated by the same operation process as described above (step S5), and the current density uniformity is determined by applying the same determination threshold values TL and TH thereto as mentioned above (step S6). If the resulting current density profile across the middle of the beam pattern BP, as shown in FIG. 8B, does not fall within the tolerance range from TL to TH, the aperture layout is re-modified (steps S5 to S8). In this case, the tentative inner block portions 52 in the tentative diagonal areas 22(2), 22(4), 22(6) and 22(8) may be enlarged appropriately.

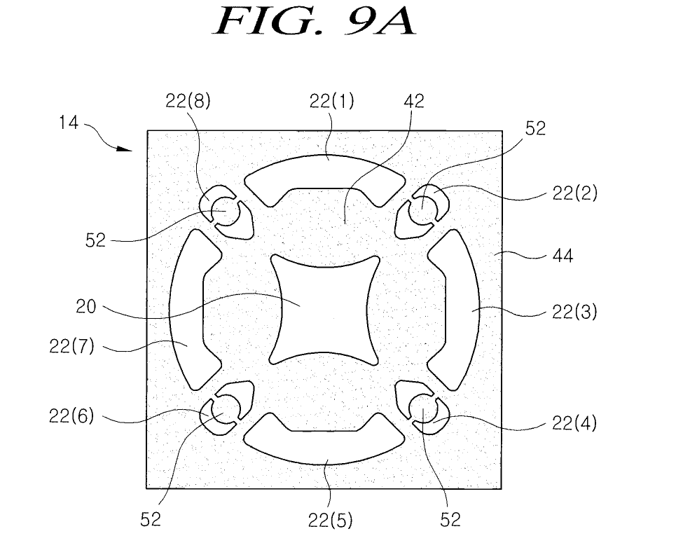

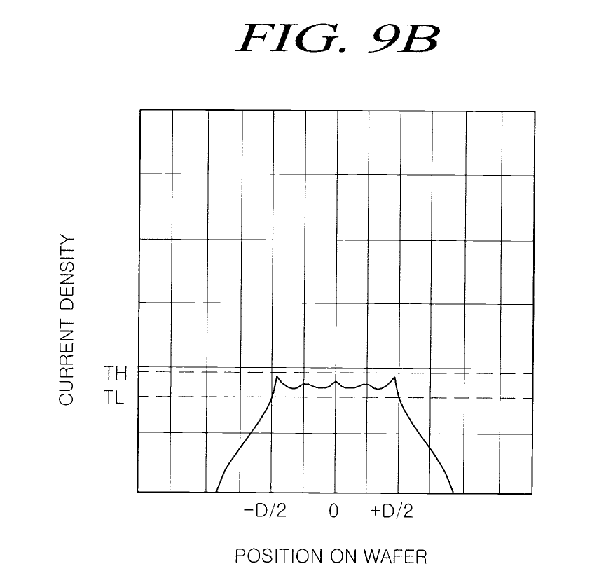

Thereafter, as for the re-modified aperture layout (FIG. 9A), the current density distribution is obtained by the same operation process as described above (step S5), and the current density uniformity is determined based on the same determination threshold values TL and TH (step S6). As a result, if a current density distribution profile within the beam pattern BP obtained from the aperture layout of FIG. 9A is as shown in FIG. 9B, current densities across the middle of the beam pattern BP can be found to fall within the tolerance range from TL to TH (step S7). Here, the aperture layout modification process is terminated, and final electron ray passing areas and inner block portions are decided (step S9).

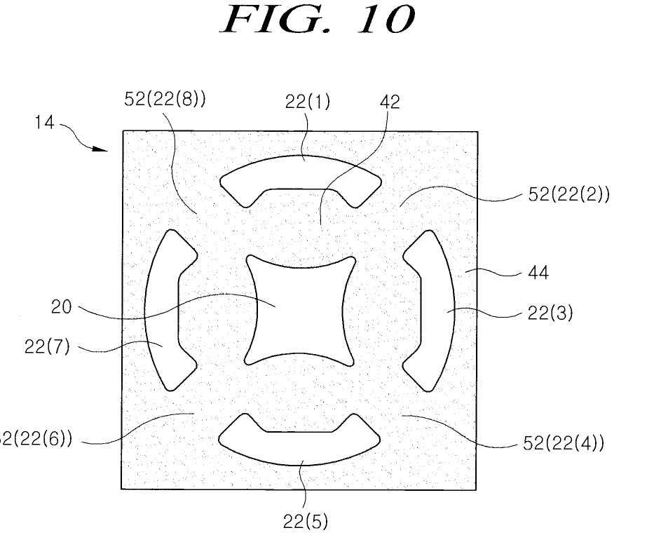

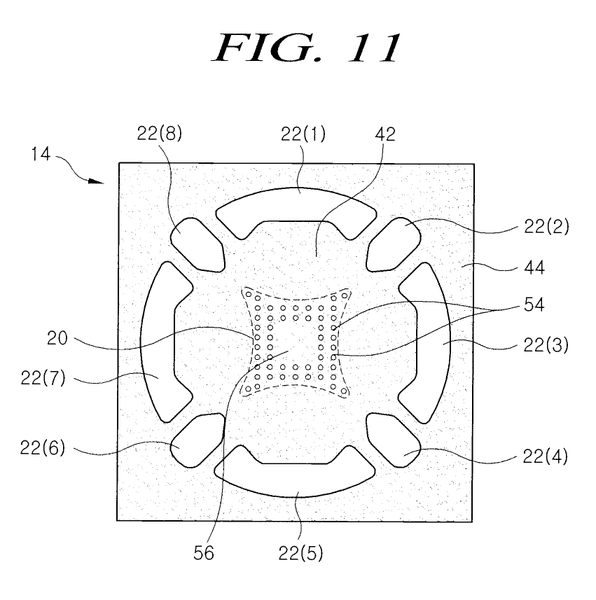

As a result of enlarging the areas of the tentative inner block portions 52 in the tentative diagonal areas 22(2), 22(4), 22(6) and 22(8), the diagonal areas 22(2), 22(4), 22(6) and 22(8) might be completely blocked by the tentative inner block portions 52, as illustrated in FIG. 10, so that this layout may be rendered nonexistent substantially.

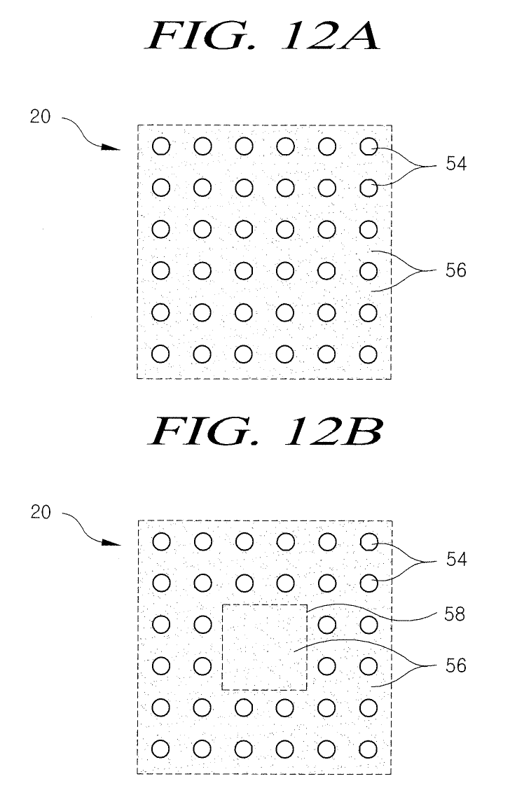

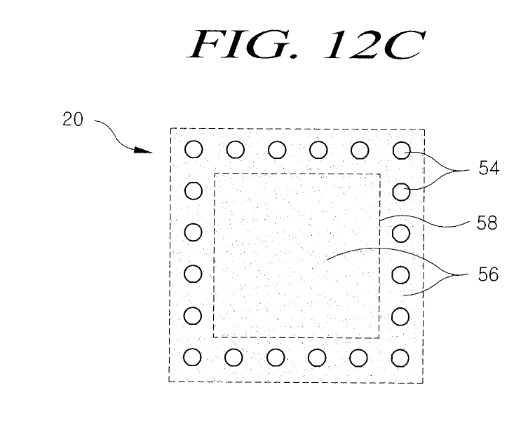

Moreover, another example of providing an inner block portion in the central passing area 20 is a configuration in which a multiplicity of small holes 54 are arranged in a specific pattern, e.g., a lattice-shaped pattern, and portion of the central passing area 20 outside the specific pattern is set as an inner block portion 56. In this case, it is desirable to provide, in the central portion of the central passing area 20, a square or circular central block region 58 where no small holes 54 exist, and to arrange the small holes 54 around this central block region 58 (FIGS. 12A to 12C). When modifying the tentative inner block portion 56 in the tentative aperture layout step, it is desirable to gradually enlarge the area of the central block region 58 according to a sequence from FIGS. 12A to 12C. Further, though not shown, it may be also possible to gradually reduce the diameters of the small holes 54, which are uniformly distributed across the central passing area 20, entirely or partially (particularly at the central portion of the central passing area 20) while maintaining the arrangement pattern or the number of the small holes 54 constant.

In the above-mentioned examples, though the inner block portions are provided in either one of the tentative central passing area 20 and the tentative outer passing areas 22, it is also possible to provide inner block portions in both areas and to modify them at the same time as an aperture configuration method or an aperture design method.

Though a square-shaped electron beam pattern has been formed on the target object in the above-mentioned embodiments, the present invention is not limited to a square-shaped electron beam pattern, and is also applicable to a beam shaping method of forming a rectangular shape, any quadrilateral shape or any polygonal shape of a beam pattern. As for the electron ray passing areas of the patterned beam-defining aperture in accordance with the present invention, various shapes or layouts may be employed depending on the desired electron beam pattern.

Though the aforementioned embodiments have been described for the case of forming a single electron beam pattern by a single beam shot, the present invention is not limited thereto. That is, the present invention is also applicable to a beam shaping method of forming two, four, or any other desired number of electron beam patterns by a single beam shot. It is possible to design a patterned beam-defining aperture by employing various shapes or layouts depending on the desired number of electron beam patterns by a single beam shot.

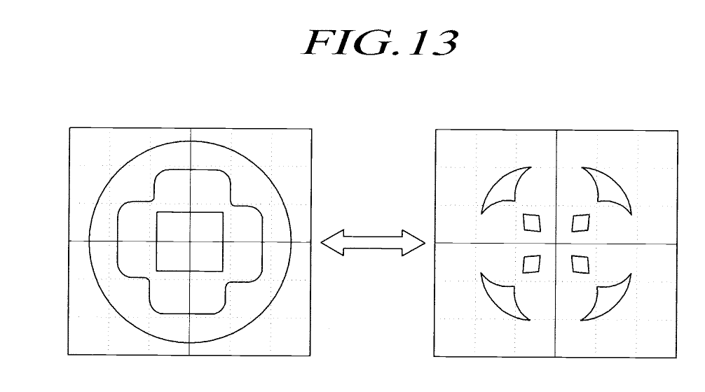

Hereinafter, a beam shaping method of forming a plurality of electron beam patterns by a single beam shot will be explained with reference to FIGS. 13 to 16.

FIG. 13 shows two aperture layouts in a single FIGURE to compare aperture sizes thereof easily. A left part of FIG. 13 is the aperture layout shown in FIG. 3 and a right part of FIG. 13 is an example aperture layout for forming four electron beam patterns by a single beam shot.

The aperture layout shown in the right part of FIG. 13 can be made by adding an example block portion to the tentative electron ray passing areas in the aperture layout of FIG. 3.

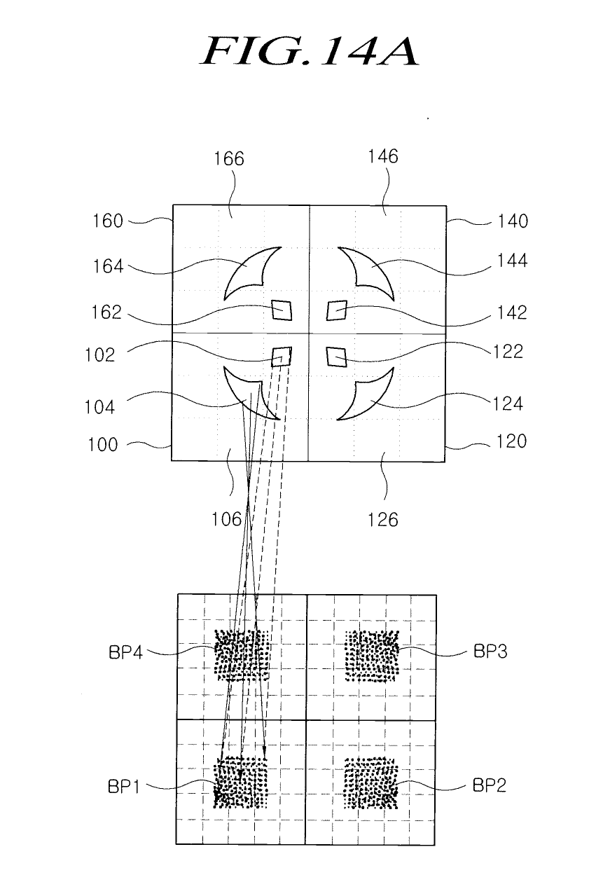

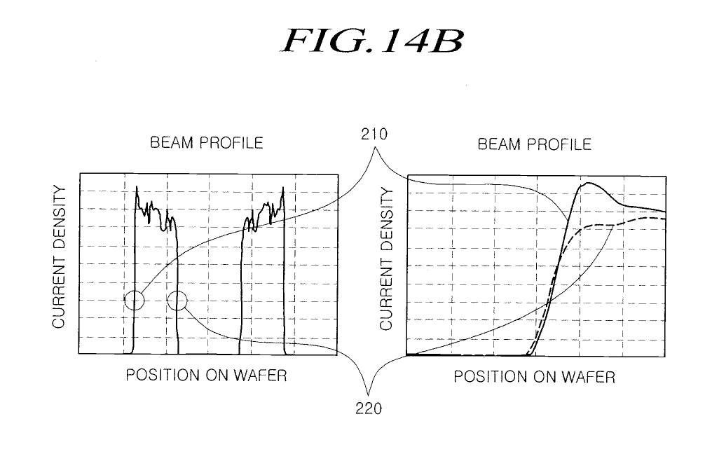

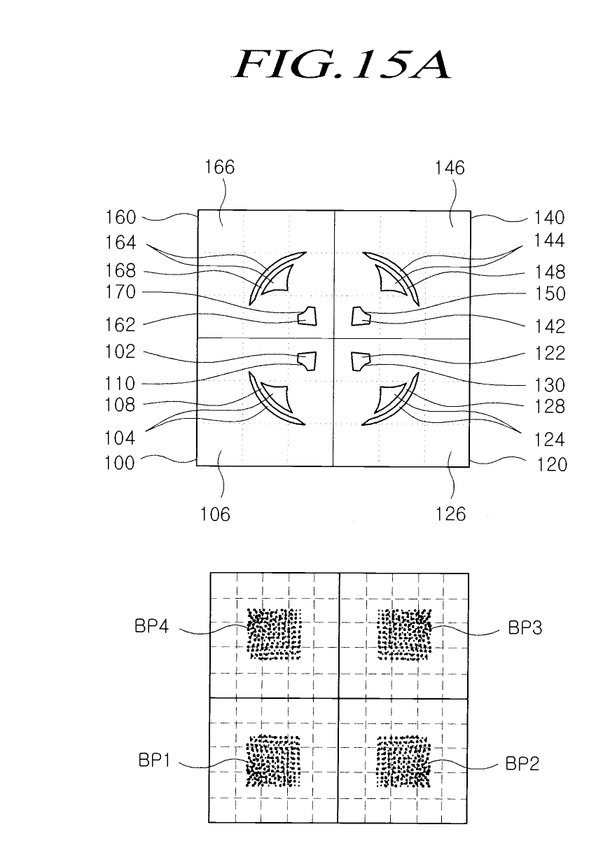

FIG. 14A shows landing points of electron rays passing through tentative electron ray passing areas within four beam patterns on a wafer. The patterned beam-defining aperture has four sections 100, 120, 140 and 160, which will be respectively referred to as a first section 100, a second section 120, a third section 140 and a fourth section 160 in the following description. Further, the beam patterns formed by electron rays landing on a wafer W after passing through the first to the fourth sections 100 to 160 will be referred to as a first beam pattern BP1, a second beam pattern BP2, a third beam pattern BP3 and a fourth beam pattern BP4, respectively.

The tentative electron ray passing areas include, as shown in FIG. 14A, four tentative central passing areas 102, 122, 142 and 162, each of which is formed as an approximately quadrilateral opening, and four tentative outer passing areas 104, 124, 144 and 164 surrounding the tentative central passing areas 102, 122, 142 and 162.

Referring to FIGS. 1 and 13A together, among the electron rays incident on the patterned beam-defining aperture 14 from the electron beam generator 10, all electron rays having passed through the tentative central passing area 102 in the first section 100 fall within the first beam pattern BP1 on the wafer W. For example, as schematically illustrated in FIG. 14A, an electron ray having passed through a left lower corner portion of the tentative central passing area 102 arrives at a left lower corner portion within the first beam pattern BP1; an electron ray having passed through a central portion of the tentative central passing area 102 arrives at a central portion within the first beam pattern BP1; and an electron ray having passed through a right upper corner portion of the tentative central passing area 102 reaches a right upper corner portion within the beam pattern BP.

Meanwhile, all electron rays having passed through the tentative outer passing area 104 in the first section 100 also fall within the first beam pattern BP1 on the wafer W.

For example, as schematically illustrated in FIG. 14A, an electron ray having passed through a left lower corner portion of the tentative outer passing area 104 arrives at a right upper corner portion within the first beam pattern BP1; an electron ray having passed through a central portion of the tentative outer passing area 104 reaches a central portion within the first beam pattern BP1; and an electron ray having passed through a right upper corner portion of the tentative outer passing area 104 arrives at a left lower corner portion within the first beam pattern BP1.

Just as the electron rays having passed through the tentative central passing area 102 and the tentative outer passing area 104 fall within the first beam pattern BP1 on the wafer W, electron rays having passed through the tentative central passing area 122 and the tentative outer passing area 124 in the second section 120 reach the second beam pattern BP2 on the wafer W; electron rays having passed through the tentative central passing area 142 and the tentative outer passing area 144 in the third section 140 fall within the third beam pattern BP3 on the wafer W; and electron rays having passed through the tentative central passing area 162 and the tentative outer passing area 164 in the fourth section 160 fall within the fourth beam pattern on the wafer W.

In the patterned beam-defining aperture 14, areas other than the tentative central passing areas 102, 122, 142 and the tentative outer passing areas 104, 124, 144 and constitute block portions 106, 126, 146 and 166, and electron rays incident on the block portions 106, 126, 146 and 166 are completely blocked off.

FIG. 14B shows a current density distribution across the middle of the beam patterns on the wafer obtained from the aperture layout of FIG. 14A. The current density distribution is calculated by investigating landing points of all electron rays passing through the tentative electron ray passing areas 102, 104, 122, 124, 142, 144, 162 and 164 within the beam patterns BP1, BP2, BP3 and BP4 on the wafer W and, then, summing up electron incident amounts on respective positions within the beam patterns BP1 to BP4. As a result, a current density distribution profile through the middle of the beam patterns may be obtained, such as shown in FIG. 14B.

As shown in a left graph of FIG. 14B, the current density distribution through the middle of the beam patterns obtained from the aperture layout of FIG. 14A is found to be non-uniform.

Meanwhile, a left edge 210 and a right edge 220 of the beam profile shown in the left graph of the FIG. 14B are enlarged in an X direction and plotted, so that a beam profile shown in a right graph of FIG. 14B is obtained. In the beam profile in the right graph of FIG. 14B, the right edge 220 is inverted in the X direction and plotted to be compared with the left edge 210.

As can be seen from these beam profiles, slopes at the left and right edges 210 and 220 are different from each other. If the slopes at the two edges 210 and 220 are different from each other, there may be caused such problems as deterioration of pattern resolution, variation in dimensions of a circuit pattern, and difference of edge roughness at the left and right portions.

Thus, it is required to modify the openings of the aperture layout shown in FIG. 14A in order to achieve a uniform current density distribution through the middle of the beam patterns and to adjust the slopes of both edges in the beam profile.

Since landing points of electron rays having passed through the openings can be calculated in advance, it is possible to change the number of electron rays falling within the beam patterns by adding block portions to the openings.

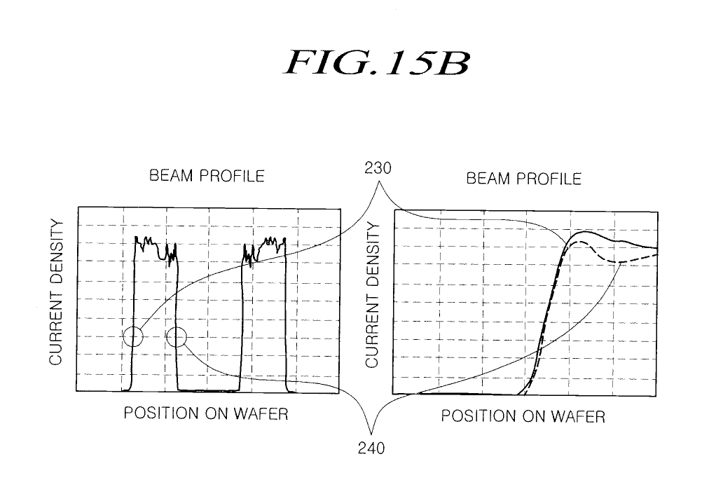

FIG. 15A is a plan view showing an example aperture layout modified by adding bridge block portions and corner block portions to the tentative electron ray passing areas in the aperture layout of FIG. 14A.

As illustrated in FIG. 15A, the tentative outer passing area 104 in the first section 100 is provided with a bridge block portion 108 which crosses the tentative outer passing area 104 in a circumferential direction, and the tentative central passing area 102 is provided with a corner block portion 110 at its one corner. The bridge block portion 108 and the corner block portion 110 block electron rays that would otherwise fall within the first beam pattern BP1 on the wafer.

As in the first section 100, the second section 120 is provided with a bridge block portion 128 crossing the tentative outer passing area 124 and a corner block portion 130 formed at one corner of the tentative central passing area 122; the third section 140 is provided with a bridge block portion 148 crossing the tentative outer passing area 144 and a corner block portion 150 formed at one corner of the tentative central passing area 142; and the fourth section 160 is provided with a bridge block portion 168 crossing the tentative outer passing area 164 and a corner block portion 170 formed at one corner of the tentative central passing area 162.

Then, as for the aperture layout (FIG. 15A) modified or renewed as described above, a current density distribution is calculated by investigating landing points of all electron rays passing through the tentative electron ray passing areas 102, 104, 122, 124, 142, 144, 162 and 164 within the beam patterns BP1, BP2, BP3 and BP4 on the wafer W and, then, summing up electron incident amounts on respective positions within the beam patterns BP1 to BP4. Here, the current density distribution can be more simply calculated by investigating landing points of the electron rays incident on the bridge block portions 108, 128, 148 and 168 and the corner block portions 110, 130, 150 and 170 within the beam patterns BP1, BP2, BP3 and BP4, respectively, and, then, excluding a current density of the electron rays incident on the bridge block portions 108, 128, 148 and 168 and the corner block portions 110, 130, 150 and 170 from the current density distribution obtained for the aperture layout (FIG. 14A) before modification. FIG. 15B shows the current density distribution across the middle of the beam patterns obtained from the aperture layout of FIG. 15A.

Thereafter, current density uniformity is determined based on the obtained current density distribution within the beam patterns BP1 to BP4. As a result, the current density distribution within the beam patterns BP1 to BP4 is found to be more uniform than the current density distribution within the beam patterns BP1 to BP4 obtained from the aperture layout of FIG. 14A.

Further, in a right graph of a beam profile in the FIG. 15B, a right edge 240 is inverted in an X direction and plotted to be compared with a left edge 230. As can be seen from these profiles, a difference between slopes at the left and right edges 230 and 240 decreases much smaller than that in the beam profile shown in FIG. 14B.

After iterating the above-described aperture layout modification process, if the current density uniformity within the beam patterns BP1 to BP4 is within a preset tolerance range, and the difference between the slopes at the left and right edges 230 and 240 is within a certain tolerance range, the aperture layout modification process is terminated, and final electron ray passing areas and block portions of the patterned beam-defining aperture are decided.

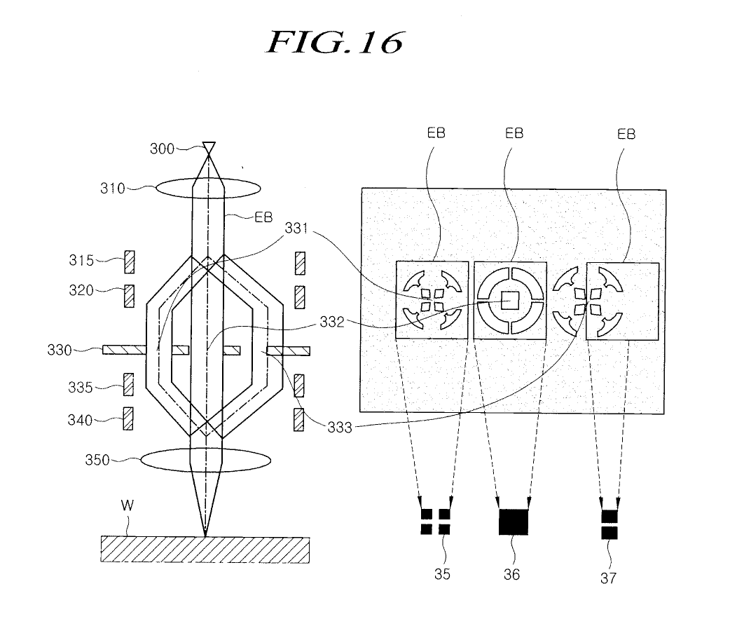

FIG. 16 is a longitudinal cross sectional view showing a configuration of an electron optical column of an electron beam lithography apparatus in accordance with another embodiment of the present invention.

The electron optical column mainly includes an electron beam generator 300 for generating an electron beam EB toward a semiconductor wafer W on a stage; a collimation lens 310 for collimating the electron beam EB from the electron beam generator 300 into a parallel beam EB; an upper pair of deflectors 315 and 320 for deflecting the electron beam EB collimated by the collimation lens 310; a patterned beam-defining aperture 330 for defining the electron beam EB deflected by the upper pair of deflectors 315 and 320 into a electron beam pattern of a desired shape and size; a lower pair of deflectors 335 and 340 for re-deflecting the electron beam EB defined by the patterned beam-defining aperture 330; and a convergence lens 350 for converging the electron beam EB re-deflected by the lower pair of deflectors 335 and 340 on the wafer W.

Here, the configuration and function of the electron beam generator 300, the collimation lens 310 and the convergence lens 350 are similar to those of the electron beam generator 10, the collimation lens 16 and the convergence lens 12 illustrated in FIG. 1, so that their detailed description will be omitted.

The upper pair of deflectors 315 and 320 serves to deflect the electron beam EB off-axis while leaving the electron beam EB parallel to the axis. The deflector 315 deflects the electron beam EB at an angle to the axis. When the electron beam EB reaches the deflector 320, the electron beam EB is deflected back to be parallel to the axis, at a distance off-axis proportional to the angular deflection of the electron beam EB induced by the deflector 315.

The patterned beam-defining aperture 330 of the electron beam lithography apparatus in accordance with another embodiment of the present invention may include, for example, a first aperture 331, a second aperture 332 and a third aperture 333.

As illustrated in the left part of FIG. 16, the first and third apertures 331 and 333 are designed to shape four beam patterns, while the second aperture 332 is designed to shape a single beam pattern.

For example, when the upper pair of deflectors 315 and 320 deflects the electron beam EB to allow it to pass through the whole part of the first aperture 331, four beam patterns 35 are formed on the wafer W. Further, when the upper pair of deflectors 315 and 320 deflects the electron beam EB to allow it to pass through the whole part of the second aperture 332, a single beam pattern 36 is formed on the wafer W. Furthermore, when the upper pair of deflectors 315 and 320 deflects the electron beam EB to allow it to pass through only a right part of the third departure 333, two beam patterns 37 are formed on the wafer W.

Though the beam patterns 37 of FIG. 16 are formed by deflecting the electron beam EB to pass through only the right part of the third aperture 333, it is also possible to form two beam patterns (not shown) at different positions from the beam patterns 37 by deflecting the electron beam EB to pass through only an upper part, a lower part or a left part of the third aperture 333. Furthermore, it is also possible to form only one beam pattern with the third aperture 333 by deflecting the electron beam EB to pass through only a left upper part, a right upper part, a left lower part or a right lower part of the third aperture 333.

Therefore, in accordance with another embodiment of the present invention, the electron beam lithography apparatus may include any desired number of apertures 330, and it is possible to form at least one beam pattern of a desired shape, a desired number, a desired position and a desired size by deflecting the electron beam by the upper pair of deflectors 315 and 320 to pass through selected one of the apertures 331, 332 and 333 and, further, to pass through only a part of the selected aperture.

That is, it is possible to control the number of electron beam patterns formed by a single beam shot by deflecting the electron beam to pass through one aperture among a plurality of apertures and/or by deflecting the electron beam to pass through only a desired part of one aperture.

The lower pair of deflectors 335 and 340 serves to deflect the electron beam EB back on-axis while leaving the electron beam EB parallel to the axis. The deflector 335 deflects the electron beam EB back towards the axis at an angle set to position the electron beam EB on-axis at the effective deflection plane of the deflector 340. The deflector 340 then deflects the electron beam EB to be colinear with the axis. The design of double-deflection deflectors is familiar to those skilled in the art.

The lower pair of deflectors 335 and 340 re-deflects the electron beam EB shaped by the patterned beam-defining aperture 331, 332 or 333 to guide it toward the convergence lens 12.

As described, by employing the beam shaping method of forming a plurality of electron beam patterns by a single beam shot, throughput can be improved greatly. By shaping the electron beam by using apertures of various shapes, a plurality of patterns can be formed by a single beam shot. Moreover, it is also possible to arrange a multiplicity of apertures having various shapes and to shape an electron beam pattern by selecting one of the apertures. Further, by allowing the electron beam to pass through only a part of the selected aperture, a desired pattern shape can be obtained.

Further, since a uniform beam profile can be obtained through the process of iterating the modification of the shape of the apertures, fluctuation in dimensions of a circuit pattern written on a resist, variation of a pattern shape, or edge roughness can be minimized.

Here, it is to be noted that the configuration of the electron optical column shown in FIG. 1 is nothing more than an example, and the present invention can be applied to other various types of electron optical columns. Furthermore, the electron beam lithography apparatus in accordance with the present invention can be employed in the manufacture of reticles as well as in the electron beam exposure of wafers.

The above description of the present invention is provided for the purpose of illustration, and it would be understood by those skilled in the art that various changes and modifications may be made without changing the technical conception and essential features of the present invention. Thus, it is clear that the above-described embodiments are illustrative in all aspects and do not limit the present invention.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. An electron beam lithography apparatus comprising:
an electron beam generator for generating an electron beam toward a target object on a stage;
a first electron lens disposed between the electron beam generator and the stage, for focusing the electron beam on the target object; and
a patterned beam-defining aperture disposed between the electron beam generator and the first electron lens to define a spot of the electron beam focused on the target object into an electron beam pattern of a desired shape and size, and having a plurality of discretely distributed electron ray passing areas for allowing a part of electron rays, which are supposed to fall within the beam pattern on the target object, to pass therethrough, among the electron rays constituting the electron beam incident from the electron beam generator,
wherein the patterned beam-defining aperture has, within at least one of the electron ray passing areas, an inner block portion for blocking electron rays which would otherwise land on a central portion of the electron beam pattern.

2. The electron beam lithography apparatus of claim 1, wherein the aperture is configured to give a 1 to N (N is an integer no smaller than 2) mapping of electron ray landing points within the electron beam pattern on the target object to electron ray passing points in the patterned beam-defining aperture.

3. The electron beam lithography apparatus of claim 1, wherein the electron ray passing areas of the patterned beam-defining aperture include a central passing area having a contour approximately corresponding to the electron beam pattern; and an outer passing area provided around the central passing area, and
an outer block portion made up of an area other than the central and outer passing areas of the patterned beam-defining aperture functions to block electron rays incident from the electron beam generator.

4. The electron beam lithography apparatus of claim 3, wherein the outer block portion blocks all or most of electron rays which would otherwise fall outside the electron beam pattern on the target object, among the electron rays constituting the electron beam incident from the electron beam generator.

5. The electron beam lithography apparatus of claim 3, wherein the outer passing area includes a multiplicity of divided outer passing areas separated from each other circumferentially around the central passing area.

6. The electron beam lithography apparatus of claim 3, wherein, in the central passing area, the inner block portion is disposed at a central portion thereof, and an opening for allowing electron rays to pass therethrough is provided around the inner block portion, and bridge portions for physically supporting the inner block portion are extended from the outer block portion to the inner block portion across the opening.

7. The electron beam lithography apparatus of claim 6, wherein, in the central passing area, a number of small holes for allowing electron rays to pass therethrough are arranged in a specific pattern, and the region of the central passing area outside the specific pattern constitutes the inner block portion.

8. The electron beam lithography apparatus of claim 7, wherein the small holes are arranged outside a central block region of a desired shape and area extended in a central portion of the central passing area.

9. The electron beam lithography apparatus of claim 8, wherein the central block region is of a square or circular shape.

10. The electron beam lithography apparatus of claim 6, wherein, in a radial direction with respect to a central point of the central passing area, the inner block portion is provided at a central portion of the outer passing area, and an opening for allowing electron rays to pass therethrough is provided around the inner block portion, and bridge portions for physically supporting the inner block portion are extended from the outer block portion to the inner block portion across the opening.

11. The electron beam lithography apparatus of claim 1, wherein disposed between the electron beam generator and the patterned beam-defining aperture is a beam blanker for blanking the electron beam by deviating the electron beam from the electron ray passing areas of the aperture.

12. The electron beam lithography apparatus of claim 11, wherein disposed between the electron beam generator and the beam blanker is a trimming aperture for trimming a cross sectional shape of the electron beam in a desired shape.

13. The electron beam lithography apparatus of claim 1, wherein disposed between the patterned beam-defining aperture and the first electron lens is a deflector for deflecting the electron beam.

14. The electron beam lithography apparatus of claim 1, wherein the electron beam generator includes a field emission electron gun for extracting electrons by applying a high electric field to a cathode tip, and
disposed in a vicinity of the electron beam generator is a second electron lens for collimating electron beams emitted from the field emission electron gun at a specific emission angle into parallel beams kept in a streamline flow state.

15. A patterned beam-defining aperture disposed, in an electron beam lithography apparatus, between an electron beam generator for generating an electron beam toward a target object on a stage and an electron lens for focusing the electron beam on the target object, for defining a spot of the electron beam focused on the target object into an electron beam pattern of a desired shape and size, the aperture comprising:
a plurality of discretely distributed electron ray passing areas for allowing a part of electron rays, which are supposed to fall within the beam pattern on the target object, to pass therethrough, among the electron rays constituting the electron beam incident from the electron beam generator; and
an inner block portion provided within at least one of the electron ray passing areas, for blocking electron rays which would otherwise land on a central portion of the electron beam pattern.

16. The patterned beam-defining aperture of claim 15, wherein the aperture is configured to give a 1 to N (N is an integer no smaller than 2) mapping of electron ray landing points within the electron beam pattern on the target object to electron ray passing points within the electron ray passing areas.

17. The patterned beam-defining aperture of claim 15, wherein the electron ray passing areas include a central passing area having an contour approximately corresponding to the electron beam pattern; and an outer passing area provided around the central passing area, and
an outer block portion made up of an area other than the central and outer passing areas functions to block electron rays incident from the electron beam generator.

18. The patterned beam-defining aperture of claim 17, wherein the outer block portion blocks all or most of electron rays which would otherwise fall outside the electron beam pattern on the target object, among the electron rays constituting the electron beam incident from the electron beam generator.

19. The patterned beam-defining aperture of claim 17, wherein the outer passing area includes a multiplicity of divided outer passing areas separated from each other in a circumferential direction around the central passing area.

20. The patterned beam-defining aperture of claim 17, wherein, in the central passing area, the inner block portion is disposed at a central portion thereof, and an opening for allowing electron rays to pass therethrough is provided around the inner block portion, and bridge portions for physically supporting the inner block portion are extended from the outer block portion to the inner block portion across the opening.

21. The patterned beam-defining aperture of claim 20, wherein, in the central passing area, a number of small holes for allowing electron rays to pass therethrough are arranged in a specific pattern, and the region of the central passing area outside the specific pattern constitutes the inner block portion.

22. The patterned beam-defining aperture of claim 21, wherein the small holes are arranged outside a central block region of a desired shape and area extended in a central portion of the central passing area.

23. The patterned beam-defining aperture of claim 22, wherein the central block region is of a square or circular shape.

24. The patterned beam-defining aperture of claim 20, wherein, in a radial direction with respect to a central point of the central passing area, the inner block portion is provided at a central portion of the outer passing area, and an opening for allowing electron rays to pass therethrough is provided around the inner block portion, and bridge portions for physically supporting the inner block portion are extended from the outer block portion to the inner block portion across the opening.

25. A method for designing a patterned beam-defining aperture disposed, in an electron beam lithography apparatus, between an electron beam generator for generating an electron beam toward a target object on a stage and an electron lens for focusing the electron beam on the target object, for defining a spot of the electron beam focused on the target object into an electron beam pattern of a desired shape and size, the method comprising:
a first step of designing the shape and size of the electron beam pattern;
a second step of analyzing trajectories of electron rays constituting the electron beam generated from the electron beam generator, based on specific conditions and constants in an electron optical system of the electron beam lithography apparatus;
a third step of setting, in a position where the patterned beam-defining aperture is to be located, a tentative electron ray passing area for allowing all or most of electron rays supposed to fall within the electron beam pattern on the target object to pass therethrough and an outer block portion for blocking all or most of electron rays that would otherwise land outside the electron beam pattern on the target object;
a fourth step of investigating a landing point of each electron ray passing through the tentative electron ray passing area within the electron beam pattern on the target object and obtaining a current density distribution within the electron beam pattern;
a fifth step of determining uniformity of the current density distribution within the electron beam pattern;
a sixth step of setting, in the tentative electron ray passing area, a tentative inner block portion having a desired shape and size, for blocking a part of electron rays to improve the uniformity of the current density distribution, and modifying an electron ray passing characteristic of the tentative electron ray passing area;
a seventh step of iterating the fourth step and the fifth step until the uniformity of the current density distribution falls within a preset tolerance range, while varying the shape or the size of the tentative inner block portion in the sixth step; and
an eighth step of determining the tentative electron ray passing area and the tentative inner block portion obtained after the completion of the seventh step as a final electron ray passing area and a final inner block portion which are to be actually fabricated in the patterned beam-defining aperture.

26. The method of claim 25, wherein, in the third step, the tentative electron ray passing area is set to be discretely distributed into a plurality of areas.

27. The method of claim 26, wherein, in the third step, the tentative electron ray passing area is set to have a tentative central passing area having a contour corresponding approximately to the electron beam pattern and a tentative outer passing area placed around the tentative central passing area.

28. The method of claim 27, wherein the tentative outer passing area includes a multiplicity of tentative divided outer passing areas separated from each other in the circumferential direction around the tentative central passing area.

29. The method of claim 28, wherein the contour of the tentative central passing area is set to have a substantially square shape, and the tentative divided outer passing areas are set to have four tentative side areas facing four sides of the tentative central passing area, respectively, and four tentative diagonal areas facing four corners of the tentative central passing area, respectively.

30. The method of claim 27, wherein, in the sixth step, the tentative inner block portion is set in a central portion of the tentative central passing area, and the area of the tentative inner block portion is gradually enlarged to improve the uniformity of the current density distribution.

31. The method of claim 27, wherein, in the sixth step, a plurality of tentative small holes for allowing electron rays to pass therethrough is arranged within the tentative central passing area in a specific pattern, and the number of the tentative small holes is gradually reduced to improve the uniformity of the current density distribution.

32. The method of claim 27, wherein, in the sixth step, a plurality of tentative small holes for allowing electron rays to pass therethrough is arranged within the tentative central passing area in a specific pattern, and the diameter of the tentative small holes is gradually reduced to improve the uniformity of current density distribution.

33. The method of claim 27, wherein, in the sixth step, the tentative inner block portion is set at a central portion of the tentative outer passing area in a radial direction with respect to a central point of the tentative central passing area, and the area of the tentative inner block portion is gradually enlarged to improve the uniformity of the current density distribution.

34. A patterned beam-defining aperture disposed, in an electron beam lithography apparatus, between an electron beam generator for generating an electron beam toward a target object on a stage and an electron lens for focusing the electron beam on the target object, for defining a multiplicity of spots of the electron beam focused on the target object into electron beam patterns of a desired shape and size by a single beam shot, the aperture comprising:
a plurality of discretely distributed electron ray passing areas for allowing a part of electron rays, which are supposed to fall within the beam patterns on the target object, to pass therethrough, among the electron rays constituting the electron beam incident from the electron beam generator; and
an inner block portion provided within at least one of the electron ray passing areas, for blocking electron rays which would otherwise to land on a portion of the electron beam patterns.

35. An electron beam lithography apparatus comprising:
an electron beam generator for generating an electron beam toward a target object on a stage;
a first electron lens disposed between the electron beam generator and the stage, for focusing the electron beam on the target object; and
a patterned beam-defining aperture disposed between the electron beam generator and the first electron lens to define a multiplicity of spots of the electron beam focused on the target object into electron beam patterns of a desired shape and size by a single beam shot, and having a plurality of discretely distributed electron ray passing areas for allowing a part of electron rays, which are supposed to fall within the beam patterns on the target object, to pass therethrough, among the electron rays constituting the electron beam incident from the electron beam generator,
wherein the patterned beam-defining aperture has, within at least one of the electron ray passing areas, an inner block portion for blocking electron rays which would otherwise land on a portion of the electron beam patterns.

36. An electron beam lithography apparatus comprising:
an electron beam generator for generating an electron beam toward a target object on a stage;
a first electron lens disposed between the electron beam generator and the stage, for focusing the electron beam on the target object;
a multiplicity of patterned beam-defining apertures, each disposed between the electron beam generator and the first electron lens to define at least one spot of the electron beam focused on the target object into at least one electron beam pattern of a desired shape and size by a single beam shot, and having a plurality of discretely distributed electron ray passing areas for allowing a part of electron rays, which are supposed to fall within said at least one beam pattern on the target object, to pass therethrough, among the electron rays constituting the electron beam incident from the electron beam generator; and
a first deflector disposed between the electron beam generator and the multiplicity of patterned beam-defining apertures, for selecting one aperture through which the electron beam passes among the multiplicity of patterned beam-defining apertures by deflecting the electron beam,
wherein the patterned beam-defining aperture has, within at least one of the electron ray passing areas, an inner block portion for blocking electron rays which would otherwise land on a portion of said at least one electron beam pattern.

37. The electron beam lithography apparatus of claim 36, further comprising:
a second deflector disposed between the multiplicity of patterned beam-defining apertures and the first electron lens, for re-deflecting the deflected electron beam to land on said at least one electron beam pattern.

38. The electron beam lithography apparatus of claim 36, wherein the first deflector controls the number of electron beam patterns by deflecting the electron beam to pass through only a desired part of the selected aperture.
